(19) United States
(12) Patent Application Publication
(10) Pub. No.: US 2006/0254911 A1
(43) Pub. Date: Nov. 16, 2006

(54) Gas sensor module with contactless interface

(75) Inventors: Peter Lindmueller, Essingen (DE); Martin Lohmann, Gerlingen (DE)

Correspondence Address: BACON & THOMAS, PLLC, 625 SLATERS LANE, FOURTH FLOOR, ALEXANDRIA, VA, 22314, US

(73) Assignee: Endress + Huaser Conducta GmbH + Co. KG, Gerlingen (DE)

(21) Appl. No.: 10/549,751

(22) PCT Filed: Mar. 25, 2004
(86) PCT No.: PCT/EP04/03176

§ 371 Date: Jul. 11, 2006

(30) Foreign Application Priority Data
Mar. 26, 2003 (DE) 103 13 639.8

(51) Int. Cl. G01N 27/26

(52) U.S. Cl. 204/424

(57) ABSTRACT

A gas sensor module includes: a primary sensor for the registering of a gas concentration; a digital data memory for storing sensor data or process data; and an interface for connecting to a superordinated unit for energy supply of the gas sensor module and for data exchange between the gas sensor module and the superordinated unit, with the interface being a contactless interface. A transmitter module operates at least one such gas sensor module and includes: a contactless interface for data exchange with the gas sensor module and for energy supply to the gas sensor module; and a communications circuit for output of at least one signal dependent on the measured data.

The present invention relates to a gas sensor, especially an electrochemical gas sensor, for connection to a transmitter.

Electrochemical gas sensors serve for monitoring the atmosphere according to various criteria. For instance, in the case of monitoring maximum allowable concentration MAC, the environment of a workplace is monitored for toxic components. Equally, gas sensors are used for LEL/UEL-monitoring. LEL/UEL concerns concentration of explosive mixtures, thus the lower explosive limit and the upper explosive limit. Another frequently monitored parameter is asphyxia, thus depletion of oxygen, both in intentional and in unintentional manner.

In many applications, the gas sensors undergo aging, so that they must frequently be replaced after a short period of operation, or they must be recalibrated. Calibration on site is, however, encumbered with greater difficulties, since the gas sensors are frequently mounted at difficultly accessible locations.

The firm Dräger provides a modular gas monitoring system, which is composed of a transmitter module referred to as Polytron 2 and replaceable sensor modules connectable thereto. The sensor modules include, besides the actual electrochemical gas sensor element, hereinafter also referred to as “primary sensor”, an integrated temperature sensor and a data memory, especially an EEPROM. The data memory stores sensor-specific data, such as gas types, sensitivity, manufacturing data, and the date of the last calibration. In so far as the data are stored in the sensor module and not in the transmitter, the sensor modules can be comfortably calibrated in a laboratory. The transmitter module recognizes a new sensor and tunes itself automatically to the new sensor. The output signal of the transmitter module is an analog 4 . . . 20 mA signal, or a digital signal according to the HART-standard.

Communication between sensor module and transmitter module, and the supply of energy to the sensor module, occur via an interface having plug contacts, which effect a galvanic coupling between circuitry of the sensor module and circuitry of the transmitter module. This is disadvantageous in that the plug contacts can degrade in corrosive environments. This can compromise signal transfer between the modules. Additionally, there is the danger of a spark discharge at the plug contacts during replacement of a sensor module. This is especially to be avoided in explosion-endangered environments.

An object of the present invention is, therefore, to provide a gas sensor module, which overcomes these disadvantages of the state of the art.

The object is achieved according to the invention by the gas sensor module as defined in the independent claim 1, the transmitter module as defined in the independent claim 8 and the modular gas sensor arrangement as defined in the independent claim 10.

The gas sensor module of the invention includes: A primary sensor for registering a gas concentration; a digital data memory for storing sensor data or process data; and an interface for connecting to a superordinated unit for data exchange with the superordinated unit and for energy supply to the gas sensor module from the superordinated unit, and for the reading and/or writing of digital data from and/or to the digital memory, with the interface of the gas sensor module being a contactless interface. The contactless interface can, for example, be embodied as a contactless plug, or as a socket for a complementary, contactless plug.

The term “contactless” means that the sensor-side interface is electrically, or galvanically, insulated from the transmitter-side interface. The contactless interface can be, for example, an optical, capacitive or inductive interface, with an inductive interface being presently preferred. A corresponding interface is described, for example, in the European Patent Application No. 1 216 079 of this assignee. Such European patent application is incorporated here by reference for details of the construction of the interface. The superordinated unit is especially a suitable transmitter module or another suitable device for the registering and processing of the data of the gas sensor module. The connecting of the interface of the gas sensor module to the superordinated system can be accomplished directly or via a connection cable, which has a suitable contactless interface. The contactless interface can be embodied, for example as a socket or as a plug for a complementary, contactless socket.

Preferably, all surfaces of the interfaces of the gas sensor module and of the transmitter module are corrosion resistant, whereby influences of a corrosive environment on the data exchange and the energy supply can be avoided. In so far as the surfaces of the interfaces are hermetically sealed and especially exhibit no openings for electrical contacts, the surface material of the interfaces can be matched simply to the particular corrosive media, and a building kit system of interface materials can be provided, which are optimized for the particular use environment.

Fundamentally, it is not important to the invention, whether the gas sensor module has all electronic circuits required for operation of the gas sensor module, and whether the data memories are written and/or read from circuits of the gas sensor module, or whether the writing and/or reading of the data occurs from the, in each case, connected, superordinated unit.

The gas sensor module of the invention includes, in a preferred form of embodiment, an analog-digital converter, which generates a digital signal, which is a function of the gas-concentration-dependent, analog signal of the primary sensor.

The gas sensor module of the invention preferably also includes a microprocessor, which, on the one hand, controls the data exchange between the interface of the gas sensor module and the superordinated system, and, on the other hand, controls the reading and writing of the digital data memory. Especially preferredly, the analog-digital converter is integrated into the microprocessor. For simple embodiments of the present invention, a microprocessor can, however, be omitted from the modular gas sensor. The reading and/or writing of data from and/or to the digital data memory can, in this case, be controlled by the superordinated system, e.g. by the transmitter module.

Preferably, the gas sensor module has a housing, in which the data memory, the interface and, as required, other electronic components, such as an analog-digital converter and a microprocessor are integrated.

In an especially preferred form of embodiment, a temperature sensor is integrated into the gas sensor module, in order to be able to take into consideration the temperature and its influence on the sensitivity of the primary sensor when evaluating the basic signals of the primary sensor. The digital data memory is preferably a data memory which can be written-to multiple times and/or one time. Currently, EEPROMS are especially preferred, with EPROMS being fundamentally likewise suitable.

The digital data memory can store especially one or more of the following data:

The gas, or gas mixture, to be registered;

calibration date;

the determined sensitivity of the sensor at a first temperature, especially 25 deg C.;

the temperature offset;

logistical information, for example a SAP-code and/or an order number; the series number;

the operating temperature range;

the nominal range of gas concentration;

the extreme values of the operating temperature;

the extreme values of the operating gas concentration;

identification of a technician (for auditing the calibration);

the in-service time;

the sensor-check-system-status;

the measured value of gas concentration; and

the measured value of temperature.

The superordinated unit, e.g. the transmitter module, can preferably access all of the stored data with a read command. Preferably, the superordinated unit, e.g. the transmitter module, can cause storage of a selection of the above data in the memory using a write command.

The transmitter module of the invention for operating at least one gas sensor module includes a contactless interface for receiving data from the gas sensor module and, if necessary, for transmitting data to the gas sensor module, as well as for energy supply to the gas sensor module, with the data including sensor-specific data and measured data; and a communications circuit for outputting at least one signal dependent on the measured data. The contactless interface can be embodied, for example, as a contactless plug or as a socket for a complementary, contactless plug. The communications circuit can be, for example, a circuit for generating a 4 . . . 20 mA signal, a HART-modem, or an interface for connecting to a data bus, for example a Fieldbus Foundation data bus or a PROFIBUS data bus.

The modular gas sensor arrangement of the invention includes a transmitter module of the invention and at least one gas sensor module of the invention suitable for use with the transmitter module.

In an embodiment of the invention, a plurality of gas sensor modules of the invention are connected directly or via cable with suitable contactless interfaces to a superordinated unit, for example a transmitter of the invention. The gas sensor modules can, in such case, be, for example, either specifically for different gas types or mixtures and/or they can monitor the concentration of the same gas type at different sites.

Data transmission via cable with contactless interfaces for connection to a sensor module and/or to a transmitter module are, for example, described in the not yet published, German patent application 102 20 450 of the present assignee, to which reference is made for details. A suitable type of transmission of data and energy within the cable harness, i.e. between the gas-sensor-module-side interface of the cable and the connection to the superordinated unit, occurs, for example, according to the RS485 protocol. Details in this connection are to be taken from the cited application.

Further features of the invention will be evident from the dependent patent claims, the description of the examples of embodiments and the drawings, the figures of which show as follows:

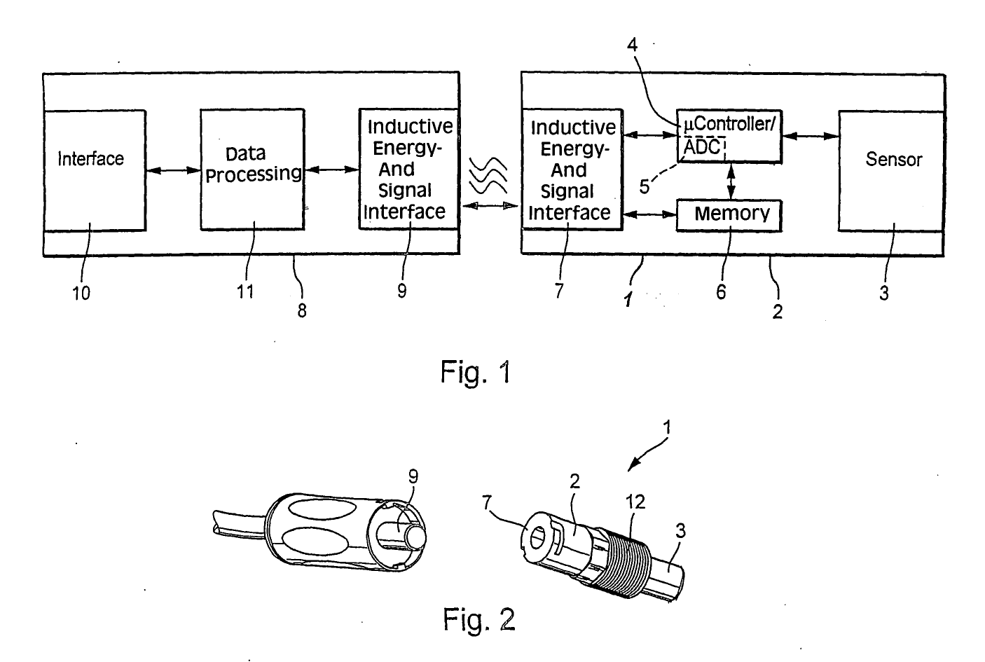

FIG. 1 a block diagram of the modular gas sensor arrangement of the invention; and

FIG. 2 a perspective view of the mechanical design of the interface of a gas sensor module.

An example of an embodiment of the invention will now be explained on the basis of FIGS. 1 and 2. The block diagram in FIG. 1 shows a gas sensor module 1 having a sensor housing 2 and a primary sensor 3 arranged therein. The primary sensor contains an electrochemical gas sensor element. Also arranged in housing 2 is a microprocessor 4, which preferably has an integrated analog-digital converter (ADC). Microprocessor 4 is, on the one hand, coupled with the analog outputs of the primary sensor 3, and, on the other hand, connected with a digital memory 6, which, in this form of embodiment, is an EEPROM. Finally, the microprocessor 4 is connected with an inductive interface 7, via which, on the one hand, the energy supply of the gas sensor module 1 occurs and, on the other hand, the data transmission from and to a superordinated unit is accomplished. In this case, the superordinated unit comprises a transmitter module 8. Optionally, also a direct connection between the memory 6 and the interface 7 can be provided.

The transmitter module 8 includes a transmitter-side, inductive interface 9, for energy supply of the gas sensor module 1 and for the digital data exchange with the gas sensor module 1. Additionally, the transmitter module includes a data processing unit 11, which is coupled with the transmitter-side, inductive interface 9 and a system-side interface 10. At the system-side interface, measured data can be output and device-specific data can be exchanged. For this, any established protocol can be used, such as, for example, the HART, Fieldbus Foundation or PROFIBUS protocols.

In measurement operation, the microprocessor 4 receives from the primary sensor at least one analog signal, which depends on the gas concentration, and, preferably, also a temperature-dependent, analog signal. The analog signals are converted into digital signals by the ADC 5. The digital signals are, on the one hand, stored in the data memory 6, and, on the other hand, can be output via the inductive interface 7 to the transmitter module 8.

Concerning details of the inductive data transfer and energy supply, reference is made again to the European Patent Application No. 1 216 079, incorporated here by reference.

The parameters for the evaluating of the signals dependent on gas concentration and, if present, the temperature data are stored in the form of calibration data in the data memory 6. The calibration data are, following a read command of the transmitter module 8, output to the inductive interface 7, either via the microprocessor 4 or directly, in order to be available to the data processing unit 11 of the transmitter module 8 for further processing, such as error compensation, etc.

At the first calibration, or at a recalibration, of the gas sensor module 1, transmitter-side write-commands are output for the storing of the determined calibration data, this resulting in the storing of the data in the EEPROM 6.

FIG. 2 shows an example of an embodiment for the mechanical arrangement of the housing 2 of the gas sensor module 1 on a rod-shaped, primary sensor 3, especially a glass electrode.

Housing 2 has on its outer diameter a screw thread 12, with which the modular gas sensor 1 can be mounted in an assembly. The housing 2 has a cylindrical end section facing away from the primary sensor 3. In the lateral surface of this cylindrical end section are arranged the recesses of a bayonet connection. The cylindrical end section contains the inductive interface 7. On the end of housing 2 is a cylindrical, axial, blind hole, which serves to receive a housed ferrite core of a transmitter-side, inductive interface 9. In the case of the example of an embodiment, the transmitter-side, inductive interface 9 is embodied as a plug on a cable connected with a transmitter module. Equally, the transmitter-side interface 9 can be embodied directly on a transmitter module housing, or the like. The plug has a sleeve-like extension on its end facing the gas sensor module 1. The extension coaxially surrounds the ferrite core and at least a part of the cylindrical end section of the housing 2, when the plug is secured to the housing 2. Radially inwardly extending protrusions on the sleeve-like extension then engage with the recess of the bayonet connection, in order to secure the plug.

1-10. (canceled)

11. A gas sensor module, comprising:
a primary sensor for the registering of a gas concentration;
a digital data memory for storing sensor data or process data; and
a contactless interface for connecting to a superordinated unit for supplying energy to the gas sensor module and for data exchange between the gas sensor module and the superorinated unit.

12. The gas sensor module as claimed in claim 11, wherein:
said contactless interface is embodied as a contactless plug or as a socket for a complementary, contactless plug.

13. The gas sensor module as claimed in claim 11, wherein:
said contactless interface comprises an inductive interface.

14. The gas sensor module as claimed in claim 11, further comprising:
an analog-digital converter for generating a digital signal, which is a function of an analog signal of said primary sensor dependent on the gas concentration.

15. The gas sensor module as claimed in claim 14, further comprising:
a microprocessor which, on the one hand, controls the data exchange between the interface of said gas sensor module and the superordinated unit, and, on the other hand, controls reading from said digital data memory and writing to said digital data memory.

16. The gas sensor as claimed in claim 15, wherein:
said analog-digital converter is integrated into said microprocessor.

17. The gas sensor module as claimed in claim 11, further comprising:
a temperature sensor.

18. A transmitter module for operating at least one gas sensor module as claimed in claim 11, comprising:
a contactless interface for data exchange with the gas sensor module and for energy supply of the gas sensor module; and
a communications circuit for output of at least one of the signals dependent on the measured data.

19. The transmitter module as claimed in claim 18, wherein: said communications circuit is a circuit for generating a 4 . . . 20 mA signal, a HART-modem, or an interface for connecting to a data bus, for example a Fieldbus Foundation data bus or a PROFIBUS data bus.

20. A modular gas sensor arrangement, comprising: a transmitter module having a contactless interface for data exchange, with a gas sensor module and for energy supply of the gas sensor module, a communications circuit for output of at least one of the signals dependent on the measured data and at least one gas sensor module suitable therefor, which includes a primary sensor, a digital data memory and a contactless interface.
